(19) United States
(12) Patent Application Publication
(10) Pub. No.: US 2003/0184770 A1
(43) Pub. Date: Oct. 2, 2003

(54) Medical image outputting system, medical image outputting method and program for the same

(75) Inventors: Wataru Motoki, Hino-shi (JP); Eiichi Akagi, Hino-shi (JP)

Correspondence Address: Squire, Sanders & Dempsey L.L.P., Suite 3000, One Maritime Plaza, San Francisco, CA, 94111-3492, US

(73) Assignee: Konika Corporation, Shinjuku-ku (JP)

(21) Appl. No.: 10/391,341

(22) Filed: Mar. 17, 2003

(30) Foreign Application Priority Data
Mar. 28, 2002 (JP) JP2002-092532

(51) Int. Cl. G06F 15/00; G06K 1/00

(52) U.S. Cl. 358/1.2; 382/128; 358/1.18

(57) ABSTRACT

A medical image outputting system for printing out a medical image obtained by a medical image photographing device, on a recording medium; includes: a designating section for designating a size of the recording medium when the medical image is printed out on the recording medium; a comparing section for comparing the size of the recording medium, which is designated by the designating section, with a size of the medical image; a print area designating section for designating a print area corresponding to the size of the recording medium, from the medical image in accordance with a result of comparing the size of the recording medium with the size of the medical image by the comparing section; and a control section for printing out the medical image on the recording medium within the print area designated by the print area designating section.

### BACKGROUND OF THE INVENTION

1. Field of the Invention

The present invention relates to a medical image outputting system, a medical image outputting method and a program for the same.

2. Description of Related Art

According to an earlier development, as a medical image photographing device, an X-ray (Roentgen or CT) inspecting device, an MRI (Magnetic Resonance Image) inspecting device and the like are known. These medical image photographing devices photograph an image in each inspecting method. An image processing is carried out for the medical image obtained by the photographing to manage the processed image in a control device corresponding to each medical image photographing device.

A doctor or an inspecting engineer which treats a patient, prints out the medical image managed in the control device on a recoding medium, such as a film or the like, by a printer. Then, the printed image is interpreted to diagnose a patient. In the print out, by using the control device, the doctor or the inspecting engineer designates one printing style between the first style in which the medical image is printed out in an equal size, and the second style in which the medical image is printed out in a reduced size. In case that the medical image is printed out in an equal size, when the size of the medical image is larger than the size of the recording medium on which the image is printed out, such as a film or the like, the control device carries out a trimming process for trimming (extracting) an image field corresponding to the size of the recording medium, such as a film, from the medical image as a print area.

In this case, the print area extracted by the control device in accordance with the trimming process, was selected by a doctor or an inspecting engineer from the print areas H1 to H9 shown in FIG. 4.

With reference to FIG. 4, the print areas H1 to H9 which can be extracted in accordance with the trimming process, will be explained. The print areas H1 to H9 are displayed so as to overlap on the medical image G1 and are ones surrounded by a trimming frame W corresponding to the film size.

In FIG. 4, the print area H1 is one obtained by overlapping the left upper part of the medical image G1 with the left upper part of the trimming frame W. The print area H2 is one obtained by overlapping the middle of the upper side of the medical image G1 with the middle of the upper side of the trimming frame W. The print area H3 is one obtained by overlapping the right upper part of the medical image G1 with the right upper part of the trimming frame W. The print area H4 is one obtained by overlapping the middle of the left side of the medical image G1 with the middle of the left side of the trimming frame W. The print area H5 is one obtained by overlapping the center of the medical image G1 with the center of the trimming frame W. The print area H6 is one obtained by overlapping the middle of the right side of the medical image G1 with the middle of the right side of the trimming frame W. The print area H7 is one obtained by overlapping the left lower part of the medical image G1 with the left lower part of the trimming frame W. The print area H8 is one obtained by overlapping the middle of the lower side of the medical image G1 with the middle of the lower side of the trimming frame W. The print area H9 is one obtained by overlapping the right lower part of the medical image G1 with the right lower part of the trimming frame W.

As described above, in the control device, because the print area to be extracted in accordance with the trimming process was selected from the print areas H1 to H9 shown in FIG. 4 according to an earlier development, the print area could not be finely adjusted. Therefore, when the print area was extracted in accordance with the trimming process, there was some possibility that a remarkable field included in the medical image was cut.

### SUMMARY OF THE INVENTION

In order to solve the above-described problems, an object of the present invention is to enable the fine adjustment of the print area when the medical image is printed out on the recording medium, such as a film or the like, and to include a remarkable field of the medical image in the print area.

That is, in accordance with the first aspect of the present invention, a medical image outputting system for printing out a medical image obtained by a medical image photographing device, on a recording medium; comprises:

a designating section for designating a size of the recording medium when the medical image is printed out on the recording medium;

a comparing section for comparing the size of the recording medium, which is designated by the designating section, with a size of the medical image;

a print area designating section for designating a print area corresponding to the size of the recording medium, from the medical image in accordance with a result of comparing the size of the recording medium with the size of the medical image by the comparing section; and

a control section for printing out the medical image on the recording medium within the print area designated by the print area designating section.

In accordance with the second aspect of the present invention, a medical image outputting method for printing out a medical image obtained by a medical image photographing device, on a recording medium; comprises:

designating a size of the recording medium when the medical image is printed out on the recording medium;

comparing the size of the recording medium, which is designated in the designating of the size of the recording medium, with a size of the medical image;

designating a print area corresponding to the size of the recording medium, from the medical image in accordance with a result of comparing the size of the recording medium with the size of the medical image in the comparing; and

printing out the medical image on the recording medium within the print area designated in the designating of the print area.

In accordance with the third aspect of the present invention, a computer-executable program for operating a control device for printing out a medical image obtained by a medical image photographing device, on a recording medium; comprising:

a designating code of designating a size of the recording medium when the medical image is printed out on the recording medium;

a comparing code of comparing the size of the recording medium, which is designated by the designating code, with a size of the medical image;

a print area designating code of designating a print area corresponding to the size of the recording medium, from the medical image in accordance with a result of comparing the size of the recording medium with the size of the medical image by the comparing code; and

a control code of printing out the medical image on the recording medium within the print area designated by the print area designating code.

According to the present invention, when the medical image is printed out, the size of the recording medium is designated. The designated size of the recording medium is compared with the size of the medical image. The medical image is printed out within the print area designated in accordance with the comparing result. Therefore, when the medical image is printed out on the recording medium, the remarkable field of the image can be designated as a print area.

The print area designating section may display the medical image on the display section, may move a trimming frame corresponding to the size of the recording medium on the medical image, and may designate a field surrounded by the trimming frame as the print area.

Because the print area is designated by moving the trimming frame corresponding to the size of the recording medium on the medical image, for example, it is possible to easily designate the remarkable field of the image as a print area.

The print area designating section may comprise a fine adjustment section for finely adjusting the print area.

Because the print area can be finely adjusted by the fine adjustment section, for example, it is possible to certainly contain the remarkable field of the image in the print area.

The field designated by the print area designating section may be printed out on the recording medium in an equal size.

The system may further comprise an input section for inputting an almost center position of the print area of the medical image when the trimming frame is displayed on the medical image displayed by the display section;

wherein the trimming frame is displayed so that the inputted almost center position coincides with a center portion of the trimming frame.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a view showing the whole structure of the medical image outputting system;

FIG. 2 is a block diagram showing an inner structure of the controller constituting the medical image outputting system;

FIG. 3 is a view showing an example of the adjustment screen; and

FIG. 4 is a view showing print areas H1 to H9 to be extracted in accordance with the trimming process according to an earlier development.

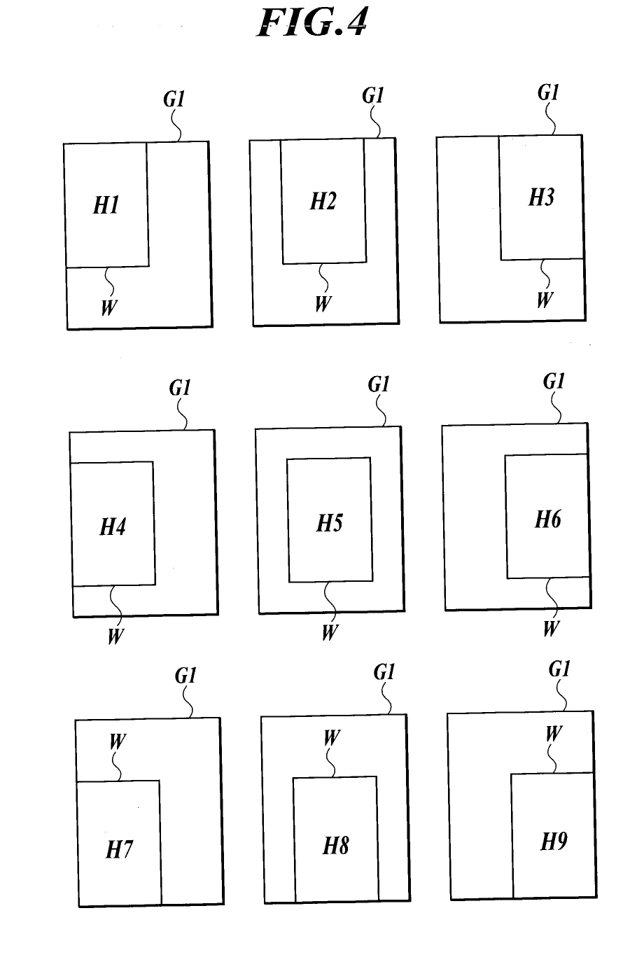

### PREFERRED EMBODIMENT OF THE INVENTION

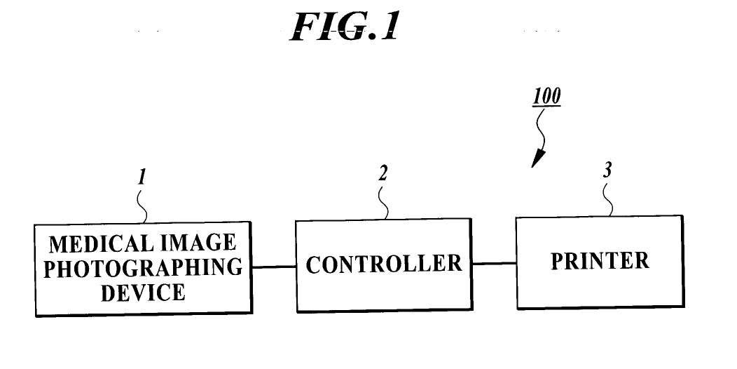

Hereinafter, an embodiment of the medical image outputting system 100 to which the present invention is applied, will be explained with reference to FIGS. 1 to 3.

Firstly, the structure of the system and the like will be explained.

FIG. 1 is a view showing the whole structure of the medical image outputting system 100. In FIG. 1, the medical image outputting system 100 comprises a medical image photographing device 1, a controller 2 and a printer 3.

The medical image photographing device 1 is, for example, a terminal disposed at a radiology department, an inspection center or the like in a hospital. The medical image photographing device 1 reads a medical image obtained by the photographing and outputs a digital image data obtained by processing the medical image, to the controller 2.

The controller 2 stores the image data outputted from the medical image photographing device 1 in a storing section 25. Further, the controller 2 outputs the image data stored in the storing section 25 in accordance with a command from an input section 22, to the printer 3 in order to print out the image on a film.

The printer 3 prints out the image on the recording medium, such as a film, in accordance with the image data outputted from the controller 2.

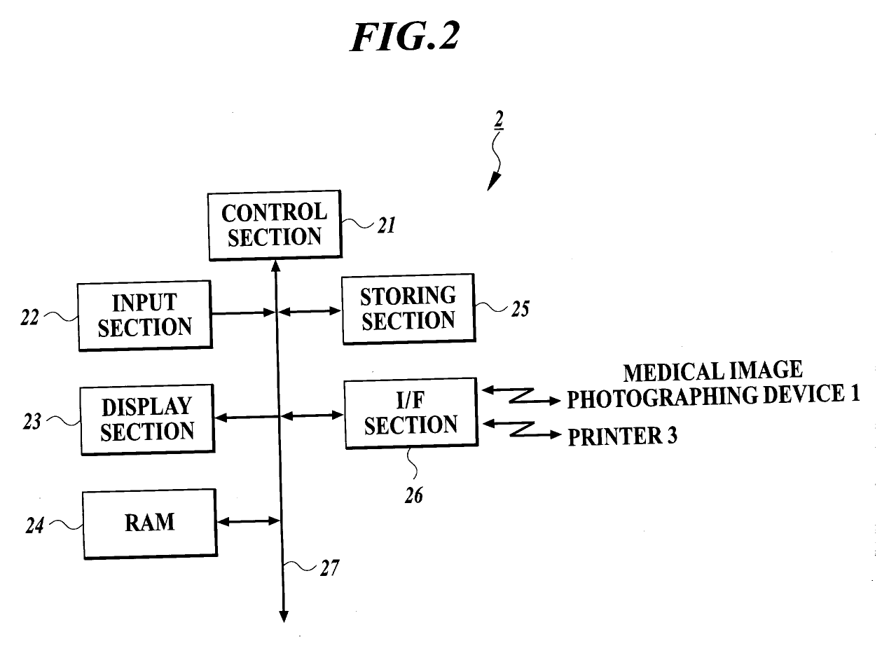

Next, the inner structure of the controller 2 constituting the medical image outputting system 100 shown in FIG. 1 will be explained with reference to FIG. 2.

In FIG. 2, the controller 2 comprises a control section 21, an input section 22, a display section 23, an RAM 24, a storing section 25 and an I/F section 26. The elements are connected with each other by a bus 27.

The control section 21 comprises a CPU (Central Processing Unit) and the like. The control section 21 reads out a system program and each type of control program stored in the storing section 25, expands these programs into the RAM 24 and concentrically controls each operation of the elements in accordance with the control programs. Further, the control section 21 carries out each process in accordance with the programs expanded into the RAM 24, stores the processing result in the RAM 24 and displays the result on the display section 23. Then, the processing result stored in the RAM 24 is saved in a predetermined saving area of the storing section 25.

When the image data is inputted into the controller 2 from the medical image photographing device 1 through the I/F section 26, the control section 21 temporarily stores the image data in the RAM 24 and stores the image data in the storing section 25.

The control section 21 reads the image data to be printed, which is designated by the input section 22, from the storing section 25 to store the image data in the RAM 24. Then, the control section 21 outputs the image data to the printer 3 through the I/F section 26 to print the image on a film by the printer 3.

Further, the control section 21 receives the designations relating to the image data to be printed out by the printer 3, the size of the film for printing out the image data, the enlarging method for the image data and the like, which are inputted by the input section 22 on a setting screen (not shown in the figures). When the “life size” is selected as an enlarging method, the control section 21 compares the size of the image to be printed out with the film size.

That is, the input section 22 has a function as a designating section. The control section 21 has a function as a comparing section.

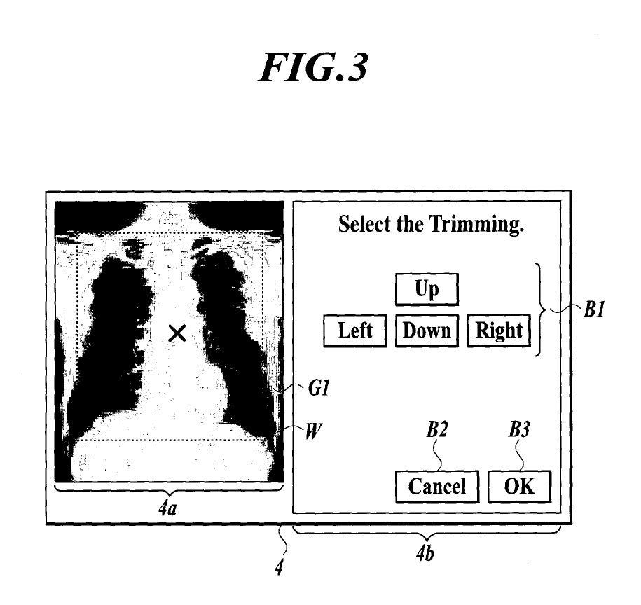

When the size of the image to be printed out is larger than the film size, the control section 21 displays an adjustment screen 4 (shown in FIG. 3) on the display section 23. In the adjustment screen 4, the print area is designated in accordance with the command inputted by the input section 22.

That is, the adjustment screen 4 has a function as a print area designating section.

The control section 21 outputs the designated print area of the image data to the printer 3 through the I/F section 26 by using the adjustment screen 4. Then, the image is printed out by the printer 3.

That is, the control section 21 has a function as a control section.

The input section 22 includes a key board having cursor key, ten key and various types of function keys, and a pointing device, such as a mouse, touch panel and the like. The input section 22 outputs a pushing signal corresponding to a pushed key of the keyboard and an operating signal generated by the pointing device, to the control section 21. As the input section 22, in case of necessity, another input device may be provided.

The display section 23 comprises an LCD (Liquid Crystal Display) display, a CRT (Cathode Ray Tube) display or the like. In accordance with a display signal outputted from the control section 21, the image and the like which is based on the input command inputted by the input section 22 and the image data outputted from the medical image photographing device 1, are displayed on the display section 23.

The RAM (Random Access Memory) 24 forms a temporary storing area for a system program, a control program, input or output data and parameters and the like, which are read out from the storing section 25 in each process controlled by the control section 21 and are executable for the controller 2.

The storing section 25 comprises a storing medium (not shown in the figures) in which the programs, the data and the like are previously stored. The storing medium is a magnetic or optical storing medium or a semiconductor memory or the like. The storing medium is fixedly provided in the storing section 25 or is detachably attached to the storing section 25. In the storing medium, a system program corresponding to the controller 2, each processing program corresponding to the system program, data which are processed in accordance with each processing program, and the like are stored. These processing programs are stored in a readable program code form. The control section 21 carries out the operations in accordance with the program code.

The I/F section 26 comprises an input interface for connecting with the medical image photographing device 1 and an output interface for connecting with the printer 3. The digital image data are inputted from the medical image photographing device 1 through the input interface. In accordance with an output command outputted from the control section 21, the image data to be printed on the film is outputted to the printer 3 through the output interface.

Next, the operation of the system will be explained.

Firstly, when the image obtained by the medical image photographing device 1 is printed on the film, the control section 21 of the controller 2 displays a setting screen (not shown in the figures) for carrying out a print setting in accordance with the input command from the input section 22.

The control section 21 receives the designations relating to the image data to be printed out by the printer 3, the size of the film for printing out the image data, the enlarging method for the image data and the like, which are inputted by the input section 22 in the setting screen (not shown in the figures). In this case, the enlarging method which can be designated is one of the “life size” and the “maximum size”. In the “life size”, the image obtained by the photographing is printed out in an equal size regardless of the film size. In the “maximum size”, the image obtained by the photographing is printed out so as to reduce the image size or to output the image in an equal size according to the film size.

When the “life size” is selected as an enlarged method, the control section 21 compares the size of the image to be printed out with the film size. When the image size is larger than the size of the recording medium, such as a film, for printing out the image, the control section 21 carries out the trimming process for extracting an image field corresponding to the film size, from the image as a print area.

In the trimming process, firstly, the control section 21 displays the adjustment screen 4 shown in FIG. 3 on the display section 23.

FIG. 3 shows an example of the adjustment screen 4. The adjustment screen 4 comprises an adjustment part 4a for roughly adjusting the print area and a fine adjustment part 4b for finely adjusting the print area.

That is, the fine adjustment part 4b has a function as a fine adjustment section.

In the adjustment part 4a, the image G1 based on the image data designated on the setting screen (not shown in the figures) and the trimming frame W corresponding to the film size designated on the setting screen are displayed. The trimming frame W is displayed so as to overlap on the image G1. The position of the trimming frame W can be changed on the image G1 in accordance with the input command from the input section 22. The area surrounded by the trimming frame W is set as a print area. The center portion of the trimming frame W may be shown by using a mark “X” in FIG. 3. The mark “X” is an indication for setting the print area.

Further, when the trimming frame W is displayed on the image G1, the center position of the print area of the image G1 may be inputted by the input section 22. In this case, the trimming frame W maybe displayed so that the input center position of the print area coincides with the center portion of the trimming frame W.

In the fine adjustment part 4b, an adjustment button group B1 for finely adjusting the position of the trimming frame W displayed on the adjustment part 4a, by moving the frame in a right and left direction and an upper and lower direction, a cancel button B2 for canceling the position of the trimming frame W, which is finely adjusted by the adjustment button group B1, and a setting button B3 for setting the position of the trimming frame W are provided.

In a method for adjusting the position of the trimming frame W, firstly, the position of the trimming frame W is roughly set by using the input section 22 (in particular, a pointing device). Then, the position of the trimming frame W is finely adjusted by using the adjustment button group B1 of the fine adjustment part 4b. Therefore, it is possible to more precisely and easily set the position of the trimming frame W.

When the setting button B3 is operated by the input section 22 in the adjustment screen 4, the area surrounded by the trimming frame W is set as a print area. The image data in the print area is outputted to the printer 3 through the I/F section 26 to print out the image by the printer 3.

As described above, in case that the image is printed out by the printer 3 in an equal size, when the image size is larger than the size of the film for printing out the image, the controller 2 carries out the trimming process for extracting the image field corresponding to the film size from the image as a print area. In this case, the controller 2 displays the adjustment screen 4 on the display section 23. Then, in the adjustment screen 4, by moving the trimming frame W in accordance with the command from the input section 22, the print area is adjusted and set. The controller 2 outputs the image data in the set print area to the printer 3. The image is printed out by the printer 3.

Therefore, in case that the image obtained by the medical image photographing device 1 is printed out on the film and is interpreted by a doctor, an inspecting engineer or the like, the print area can be adjusted so as to print out the remarkable field of the image on the film.

As a result, even though the image size is larger than the size of the recording medium, such as a film or the like, it is possible to print out the image on the recording medium in an equal size. Further, even though the recording medium is small, it is possible to print out the image field which is necessary for the diagnosis of a patient.

When the image is printed out on the recording medium, the position in which the image should be printed out on the recording medium, may be designated by the controller 2. Further, a plurality of images for which the trimming process is carried out, may be printed out on one recording medium. For example, when two image are printed out on one film, the printer 3 is controlled by the controller 2 so as to print out one image on an upper side or a left side of the film and to print out the other image on a lower side or a right side of the film. In this case, each field of the images in the film may be automatically set so as to be the half of the image field which is reserved when one image is printed out on one film. The printer 3 may be manually controlled by a user, such as a doctor, an inspecting engineer or the like, through the input section 22, or may be automatically controlled in accordance with the control program stored in the storing section 25.

Because a plurality of images can be printed out on one recording medium, it is possible to save the recording medium. Further, because the diagnosis for a patient can be carried out with one recording medium by comparing a plurality of images, it is possible to improve the accuracy of the diagnosis.

In the present embodiment, as an example, the case that the controller 2 is connected with the medical image photographing device 1 and the printer 3 through the I/F section 26, is explained. However, the present invention is not limited to this. The controller 2 may comprise a communication control section and may be connected with an external apparatus (for example, a printer 3, another printer or the like) by a network, such as LAN (Local Area Network), WAN (Wide Area Network) or the like, which is constructed in a hospital or between hospitals through the communication control section.

Further, in the present embodiment, the control section 21 of the controller 2 is separated from the medical image photographing device 1 and is connected with the medical image photographing device 1 through the I/F section 26. The present invention is not limited to this. The control section 21 may be incorporated into the medical image photographing device 1.

The present invention is not limited to the above embodiment. Various modifications can be suitably applied without departing from the gist of the present invention.

According to the present invention, when the medical image obtained by the medical image photographing device is printed out on the recording medium, it is possible to designate the remarkable field of the image as a print area.

According to the present invention, because the print area is designated by moving the trimming frame corresponding to the recording medium on the medical image, for example, it is possible to designate the remarkable field of the image as a print area.

Further, according to the present invention, because the print area can be finely adjusted by the fine adjustment section, for example, it is possible to certainly contain the remarkable field of the image in the print area.

The entire disclosure of Japanese Patent Application No. Tokugan 2002-92532 filed on Mar. 28, 2002 including specification, claims drawings and summary are incorporated herein by reference in its entirety.

What is claimed is:

1. A medical image outputting system for printing out a medical image obtained by a medical image photographing device, on a recording medium; comprising:
a designating section for designating a size of the recording medium when the medical image is printed out on the recording medium;
a comparing section for comparing the size of the recording medium, which is designated by the designating section, with a size of the medical image;
a print area designating section for designating a print area corresponding to the size of the recording medium, from the medical image in accordance with a result of comparing the size of the recording medium with the size of the medical image by the comparing section; and
a control section for printing out the medical image on the recording medium within the print area designated by the print area designating section.

2. The system of claim 1, further comprising a display section for displaying the medical image;
wherein the print area designating section displays the medical image on the display section, moves a trimming frame corresponding to the size of the recording medium on the medical image, and designates a field surrounded by the trimming frame as the print area.

3. The system of claim 1, wherein the print area designating section comprises a fine adjustment section for finely adjusting the print area.

4. The system of claim 2, wherein the field designated by the print area designating section is printed out on the recording medium in an equal size.

5. The system of claim 2, further comprising an input section for inputting an almost center position of the print area of the medical image when the trimming frame is displayed on the medical image displayed by the display section;
wherein the trimming frame is displayed so that the inputted almost center position coincides with a center portion of the trimming frame.

6. A medical image outputting method for printing out a medical image obtained by a medical image photographing device, on a recording medium; comprising:
designating a size of the recording medium when the medical image is printed out on the recording medium;
comparing the size of the recording medium, which is designated in the designating of the size of the recording medium, with a size of the medical image;
designating a print area corresponding to the size of the recording medium, from the medical image in accordance with a result of comparing the size of the recording medium with the size of the medical image in the comparing; and
printing out the medical image on the recording medium within the print area designated in the designating of the print area.

7. The method of claim 6, wherein the designating of the print area comprises: displaying the medical image; moving a trimming frame corresponding to the size of the recording medium on the medical image; and designating a field surrounded by the trimming frame as the print area.

8. The method of claim 6, wherein the designating of the print area comprises: finely adjusting the print area.

9. The method of claim 7, wherein in the printing out, the field designated in the designating of the print area is printed out on the recording medium in an equal size.

10. The method of claim 7, further comprising: inputting an almost center position of the print area of the medical image when the trimming frame is displayed on the medical image;
wherein the trimming frame is displayed so that the inputted almost center position coincides with a center portion of the trimming frame.

11. A computer-executable program for operating a control device for printing out a medical image obtained by a medical image photographing device, on a recording medium; comprising:
a designating code of designating a size of the recording medium when the medical image is printed out on the recording medium;
a comparing code of comparing the size of the recording medium, which is designated by the designating code, with a size of the medical image;
a print area designating code of designating a print area corresponding to the size of the recording medium, from the medical image in accordance with a result of comparing the size of the recording medium with the size of the medical image by the comparing code; and
a control code of printing out the medical image on the recording medium within the print area designated by the print area designating code.

12. The program of claim 11, wherein the print area designating code comprises: a code of displaying the medical image; a code of moving a trimming frame corresponding to the size of the recording medium on the medical image; and a code of designating a field surrounded by the trimming frame as the print area.

13. The program of claim 11, wherein the print area designating code comprises: a code of finely adjusting the print area.

14. The program of claim 12, wherein the control code comprises a code of printing out the field designated by the third code on the recording medium in an equal size.

15. The method of claim 12, further comprising: an inputting code of inputting an almost center position of the print area of the medical image when the trimming frame is displayed on the medical image;
wherein the trimming frame is displayed so that the inputted almost center position coincides with a center portion of the trimming frame.
